(19) United States
(12) Patent Application Publication
(10) Pub. No.: US 2014/0184124 A1
(43) Pub. Date: Jul. 3, 2014

(54) COMPUTING DEVICE AND METHOD FOR PROTECTING FAN OF COMPUTING DEVICE

(71) Applicant: HON HAI PRECISION INDUSTRY CO., LTD., New Taipei (TW)

(72) Inventors: MING-HUI CHIANG, New Taipei (TW); YAO-TING CHANG, New Taipei (TW)

(21) Appl. No.: 13/922,289

(22) Filed: Jun. 20, 2013

(30) Foreign Application Priority Data
Dec. 28, 2012 (TW) 101150869

(51) Int. Cl. H02P 29/02

(52) U.S. Cl. CPC H02P 29/028
USPC 318/490; 318/504

(57) ABSTRACT

In a method for protecting a fan of a computing device, firstly, a current supplied to the fan is read. Secondly, if the current supplied to the fan is more than or equal to a predefined current, a baseboard management controller(BMC) is controlled to send a pulse width modulation (PWM) signal to decrease a duty cycle of the fan by a predefined proportion, so that the current supplied to the fan is decreased. Thirdly, if the decreased current is more than or equal to the predefined current, the BMC is controlled to send the PWM signal to the fan to decrease the duty cycle of the fan by a predefined proportion, so as to decrease the decreased current.

### BACKGROUND

1. Technical Field

The embodiments of the present disclosure relate to computing device protection systems and methods, and more particularly to a computing device and method for protecting a fan of a computing device.

2. Description of Related Art

If a current of a fan of a computing device is greater than a maximum current of the fan, the fan malfunction. Protecting the fan of the computing device from exposure to over-current is a technology problem that needs to be solved.

### BRIEF DESCRIPTION OF THE DRAWINGS

FIG. 1 is a block diagram of one embodiment of a computing device including a fan protection system.

FIG. 2 is a block diagram of one embodiment of function modules of the fan protection system in FIG. 1.

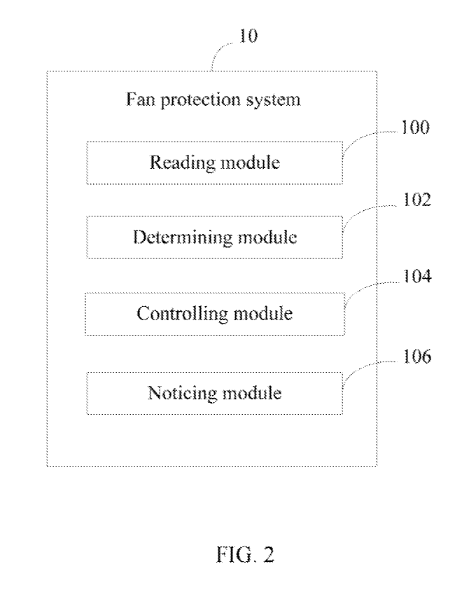

FIG. 3 is a flowchart of one embodiment of a method for protecting a fan of a computing device.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

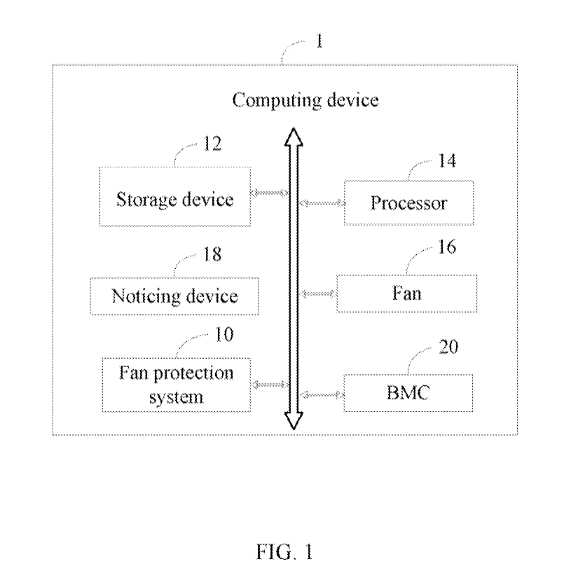

FIG. 1 is a block diagram of one embodiment of a computing device 1 including a fan protection system 10. In the embodiment, the computing device 1 comprises a storage device 12, at least one processor 14, a fan 16, a noticing device 18, and a baseboard management controller (BMC) 20. The computing device 1 may be a personal computer, a server, a personal digital assistant (PDA) device, for example.

In one embodiment, the storage device 12 (non-transitory storage device) may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a data storage medium.

The at least one processor 14 may include a central processor unit (CPU), a microprocessor, an application-specific integrated circuit, and a field programmable gate array, for example.

The fan 16 may be a fan controlled by pulse width modulation (PWM) signals. For example, the fan 16 may have 4 pins. If the duty cycle of the fan 16 is 100%, speed of the fan 16 is 12000 RPM. If the duty cycle of the fan 16 is 50%, the speed of the fan 16 is 1800 RPM. The greater a current supplied to the fan 16, the higher the speed of the fan 16. The BMC 20 may be controlled to send a PWM signal to the fan 16 to decrease the duty cycle of the fan 16 by a predefined proportion, so as to decrease the current supplied to the fan 16.

The noticing device 18 generates a notification that indicates a heat dissipation function of the fan 16 is unable to meet daily work requirements of the computer device 1. In the embodiment, the noticing device 18 may be an alarm device which can generate an alarm that indicates the heat dissipation function of the fan 16 is unable to meet daily work requirements of the computer device 1.

In one embodiment, the fan protection system 10 includes a plurality of function modules which include computerized codes or instructions that can be stored in the storage device 12 and executed by the at least one processor 14 to provide a method for protecting the fan 16 of the computing device 1.

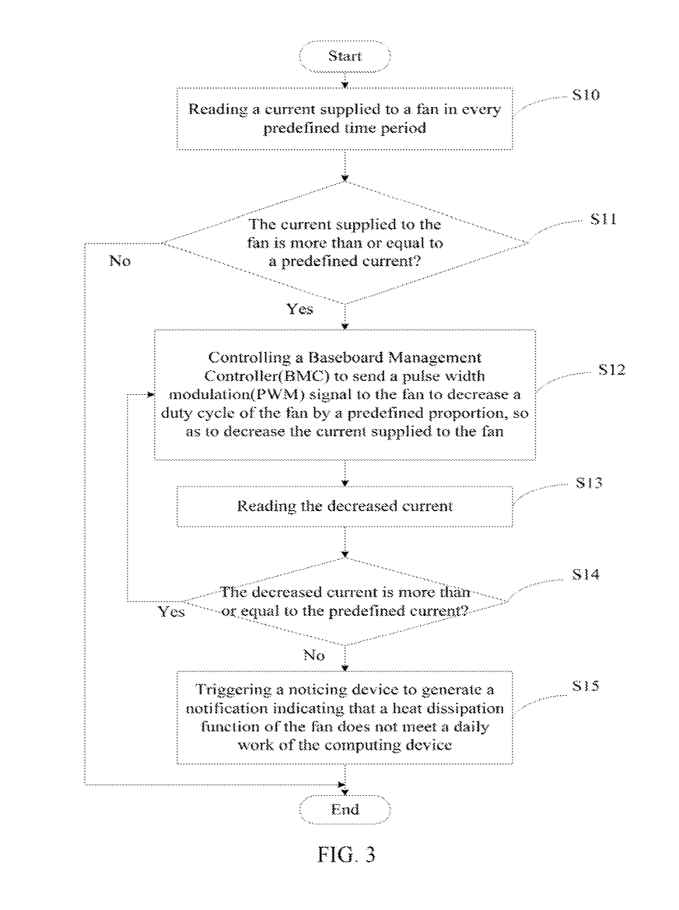

In one embodiment, the fan protection system 10 may include a reading module 100, a determining module 102, a controlling module 104, and a noticing module 106. The modules may comprise computerized codes in the form of one or more programs that are stored in the storage device 12 and executed by the at least one processor 14 to provide functions for implementing the modules. The functions of the function modules are illustrated in FIG. 3 and described below.

FIG. 3 illustrates a flowchart of one embodiment of a method for protecting the fan 16 of the computing device 1. Depending on the embodiment, additional steps may be added, others removed, and the ordering of the steps may be changed.

In block S10, the reading module 100 reads the current supplied to the fan 16 in every predefined time period. In one embodiment, the predefined time period may be determined according to user requirements, and may be defined as 10 seconds, for example.

In block S11, the determining module 102 determines whether the current supplied to the fan 16 is more than or equal to a predefined current. In the embodiment, the predefined current is a maximum rated current of the fan 16. The fan 16 may be burned when the current of the fan 16 is more than or equal to the predefined current. If the current supplied to the fan 16 is more than or equal to the predefined current, S12 is implemented. If the current supplied to the fan 16 is less than the predefined current, the flow of the method is ended.

In block S12, the controlling module 104 controls the BMC 20 to send a PWM signal to the fan 16 to decrease the duty cycle of the fan 16 by a predefined proportion, so as to decrease the current supplied to the fan 16. In one embodiment, the predefined proportion may be defined as 10 percent of the duty cycle of the fan 16. For example, the predefined current may be 3.0 A, and the current supplied to the fan 16 may be 3.6 A, the current of the fan 16 is more than the predefined current. The BMC 20 sends a PWM signal to the fan 16 to decrease the current of the fan 16 by decreasing the duty cycle of the fan 16 by the predefined proportion.

In block S13, the reading module 100 reads the decreased current of the fan 16 through the BMC 20.

In block S14, the determining module 102 determines whether the decreased current is more than or equal to the predefined current. If the decreased current is more than or equal to the predefined current, S12 is implemented. If the decreased current is less than the predefined current, S15 is implemented.

In block S15, the noticing module triggers the noticing device 18 to generate a notification indicating that the heat dissipation function of the fan 16 dose not meet a daily work of the computing device 1. In the embodiment, because the duty cycle of the fan 16 is decreased by the predefined proportion to decrease the speed of the fan 16, the heat dissipation function of the fan 16 may does not meet the daily work requirements of the computing device 1.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a baseboard management controller (BMC);
at least one processor; and
a storage device storing a computer program including instructions that, which executed by the at least one processor, causes the at least one processor to:
read a current supplied to the fan in every predefined time period;
determine whether the current supplied to the fan is more than or equal to a predefined current;
control the BMC to send a pulse width modulation(PWM) signal to the fan to decrease a duty cycle of the fan by a predefined proportion, so as to decrease the current supplied to the fan, if the current supplied to the fan is more than or equal to the predefined current;
read the decreased current supplied to the fan through the BMC;
control the BMC to send the PWM signal to the fan to decrease the duty cycle of the fan until the decreased current supplied to the fan is less than the predefined current.

2. The computing device according to claim 1, wherein the predefined current is a maximum rated current of the fan.

3. The computing device according to claim 1, wherein the predefined proportion is defined as 10 percent of the duty cycle of the fan.

4. The computing device according to claim 1, the computer program further causes the at least one processor to:
trigger a noticing device of the computing device to generate a notification indicating that a heat dissipation function of the fan does not meet a daily work requirement of the computing device.

5. A method for protecting a fan of a computing device, the method comprising:
reading a current supplied to the fan in every predefined time period;
determining whether the current supplied to the fan is more than or equal to a predefined current;
controlling a baseboard management controller(BMC) to send a pulse width modulation (PWM) signal to the fan to decrease the duty cycle of the fan by a predefined proportion, so as to decrease the current supplied to the fan, if the current supplied to the fan is more than or equal to the predefined current;
reading the decreased current supplied to the fan through the BMC;
controlling the BMC to send the PWM signal to the fan to decrease the duty cycle of the fan until the decreased current supplied to the fan is less than the predefined current.

6. The method according to claim 5, wherein the predefined current is a maximum rated current of the fan, and the fan burns out when the current supplied to the fan is more than or equal to the predefined current.

7. The method according to claim 5, wherein the predefined proportion is defined as 10 percent of the duty cycle of the fan.

8. The method according to claim 5, the method further comprising:
triggering a noticing device of the computing device to generate a notification indicating that a heat dissipation function of the fan does not a meet daily work requirement of the computing device.

9. A non-transitory computer-readable storage medium having stored thereon instructions being executed by a processor of a computing device, causes the processor to perform a method for protecting a fan of the computing device, the method comprising:
reading a current supplied to the fan in every predefined time period;
determining whether the current supplied to the fan is more than or equal to a predefined current;
controlling a baseboard management controller(BMC) to send a pulse width modulation (PWM) signal to the fan to decrease the duty cycle of the fan by a predefined proportion, so as to decrease the current supplied to the fan, if the current supplied to the fan is more than or equal to the predefined current;
reading the decreased current supplied to the fan through the BMC;
controlling the BMC to send the PWM signal to the fan to decrease the duty cycle of the fan until the decreased current supplied to the fan is less than the predefined current.

10. The storage medium according to claim 9, the predefined current is a maximum rated current of the fan, and the fan burns out when the current supplied to the fan is more than or equal to the predefined current.

11. The storage medium according to claim 9, wherein the predefined proportion is defined as 10 percent of the duty cycle of the fan.

12. The storage medium according to claim 9, the method further comprising:
triggering a noticing device of the computing device to generate a notification indicating that a heat dissipation function of the fan does not meet a daily work requirement of the computing device.
